(19) United States
(12) Patent Application Publication
(10) Pub. No.: US 2022/0242683 A1
(43) Pub. Date: Aug. 4, 2022

(54) BAKERY TRAY DESTACKER

(71) Applicant: Rehrig Pacific Company, Los Angeles, CA (US)

(72) Inventors: Peter Douglas Jackson, Alpharetta, GA (US); Derick Foster, Cumming, GA (US); Dane Gin Mun Kalinowski, Foothill Ranch, CA (US); Travis James Englert, Brea, CA (US)

(21) Appl. No.: 17/591,998

(22) Filed: Feb. 3, 2022

Related U.S. Application Data
(60) Provisional application No. 63/145,445, filed on Feb. 3, 2021.

(51) Int. Cl. B65G 59/06; B65G 61/00; B65G 13/02

(52) U.S. Cl. CPC B65G 59/067; B65G 2201/0258; B65G 13/02; B65G 61/00

(57) ABSTRACT

A tray destacker includes a pair of spaced-apart carriages movable vertically relative to a frame. An indexing member is carried by each of the carriages. Each indexing member is movable between a deployed position in which the indexing members are closer to one another and a retracted position in which the indexing members are further from one another. A controller is programmed to automatically split a large stack of trays into two or more smaller stacks.

### BACKGROUND

Full stacks of loaded bakery trays are transported from the bakery to the distribution center (DC) in order to be reorganized and distributed to multiple store locations. The 8′ tall stacks are unloaded from the trailer at the DC and typically manually downstacked by employees with the help of a small ladder.

Each loaded bakery tray may weigh up to 20 lbs, with a full stack weighing up to 300 lbs. Overhead downstacking loaded bakery trays is a time-consuming process, as well as a safety issue that can lead to potential injury, such as back strain.

### SUMMARY

The bakery tray destacker is a semi-automated solution that splits 8′ tall stacks of loaded bakery trays approximately in half. The destacker eliminates the manual downstacking process, saving time and reducing potential injuries.

The bakery tray destacker is a simple and effective device that requires minimal operator interaction. The operator simply loads the destacker with a full stack of bakery trays, activates the destacking process by pressing a button, and walks away. The destacker automatically does the rest by separating the stack roughly in half, creating two separate smaller stacks of trays. The resulting two half stacks of bakery trays are much easier to handle and move around the DC to prepare for distribution to a store.

### BRIEF DESCRIPTION OF THE DRAWINGS

FIG. 1 is a perspective view of a tray destacker according to one embodiment.

FIG. 2 is a rear perspective view of the tray destacker of FIG. 1.

FIG. 3 is a top view of the tray destacker of FIG. 1.

FIG. 4 is a front view of the tray destacker of FIG. 1.

FIG. 5 shows the tray destacker of FIG. 4 with the indexing members in the retracted position.

FIG. 6 is an enlarged view of one of the carriages of the tray destacker of FIG. 1 showing internal components schematically.

FIG. 7 shows a user bringing a large stack of trays toward the tray destacker of FIG. 1.

FIG. 8 shows the large stack of trays being loaded into the tray destacker.

FIG. 9 shows the large stack of trays of FIG. 8 loaded into the tray destacker.

FIG. 10 shows the destacker of FIG. 9 initially separating the large stack of trays into two smaller stacks of trays.

FIG. 11 shows the lower stack of FIG. 10 moved laterally by the destacker.

FIG. 12 shows the two stacks of FIG. 11 side-by-side on the destacker.

FIG. 13 is a flowchart for the operation of the destacker.

### DETAILED DESCRIPTION

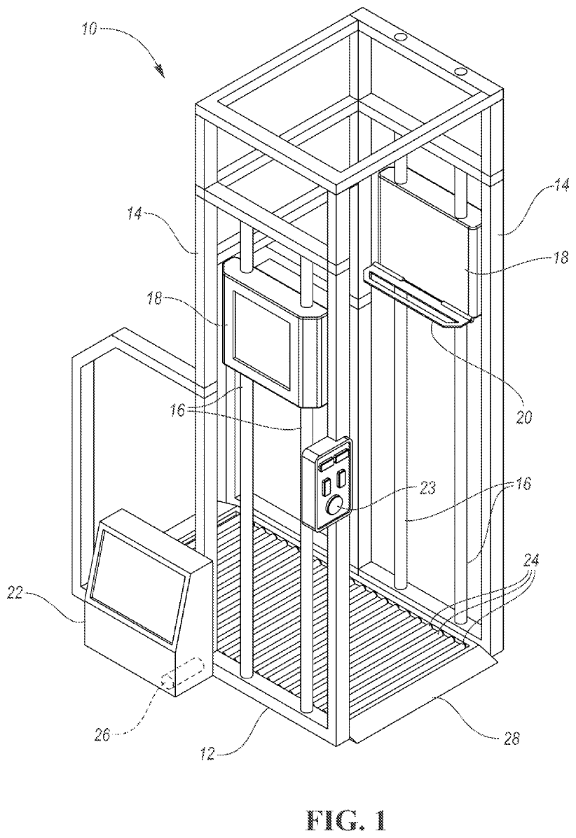

A tray destacker 10 is shown in FIG. 1. The tray destacker 10 includes a base 12 and a frame including side walls 14 extending upward from side edges of the base 12. A pair of vertical rails 16 extend upward in each side wall 14. A carriage 18 is secured to each pair of vertical rails 16, i.e. one carriage 18 in each side wall 14. The carriage 18 includes motors (or hydraulics) for moving the carriage 18 up and down on the vertical rails 16. The motors may engage the rails 16 or there may be an external lifting mechanism for each carriage 18. Alternatively, the rails 16 may be threaded and engage threads in the carriage, and a motor rotating one or both of the rails can raise and lower the carriage 18.

Each carriage 18 further includes one or more retractable indexing members 20 that are movable in a direction perpendicular to the vertical rails, i.e. the indexing members 20 of one carriage 18 are movable toward and away from the indexing members 20 of the other carriage 18. For example, as shown, the indexing members 20 could be pivotably mounted to the carriages 18 and moved inward and outward by motors, hydraulics, magnets, etc.

The carriages 18 and indexing members 20 are controlled by a controller 22 which may be mounted to one of the side walls 14. The controller 22 includes a processor and electronic storage. The electronic storage stores instructions which when executed by the processor perform the operations described herein.

The base 12 includes a plurality of rollers 24. The rollers 24 may be rotatably driven by a motor 26 controlled by the controller 22 which is programmed to control the rollers 24 as described herein. Alternatively, a conveyor belt or other movable surface may be used in place of the rollers 24. Alternatively, the rollers 24 could be free rolling. A front ramp 28 is inclined from a floor on which the tray destacker 10 is supported to the upper surface of the rollers 24.

The base 12 includes a first portion generally defined between the one pair of rails 16 and the other pair of rails 16, i.e. the area accessible by the carriages 18. The base 12 also includes a second portion rearward of the first portion. The rollers 24 cover the first portion and the second portion The first portion and the second portion are generally the same size.

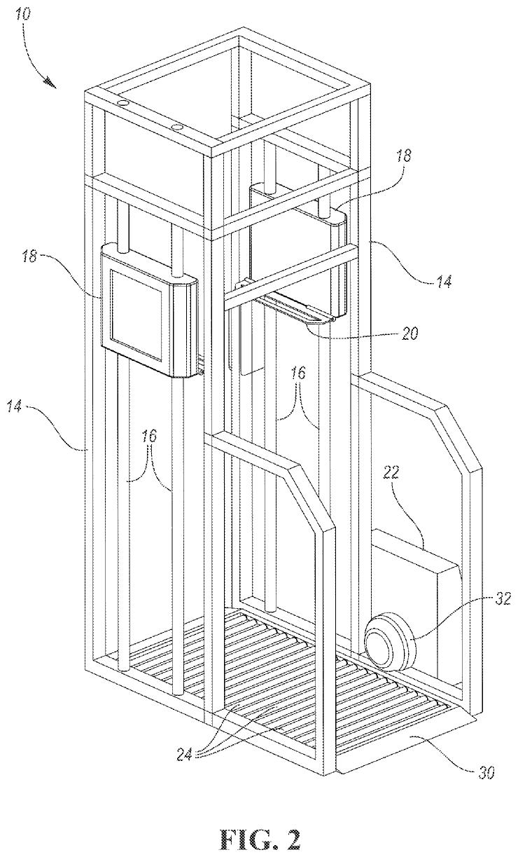

FIG. 2 is a rear perspective view of the tray destacker 10 of FIG. 1. A rear ramp 30 is angled downward from the upper surface of the rollers 24 to the floor. A presence sensor 32 is positioned adjacent the second portion of the base 12 and configured to detect the presence of trays in the second portion of the base 12.

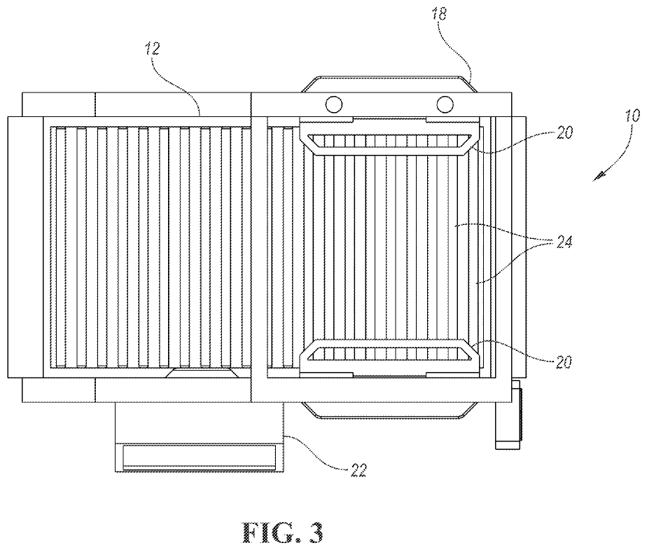

FIG. 3 is a top view of the tray destacker of FIG. 1. The indexing members 20 are shown in their deployed positions in which they extend toward one another, over the first portion of the base 12 and over the rollers 24.

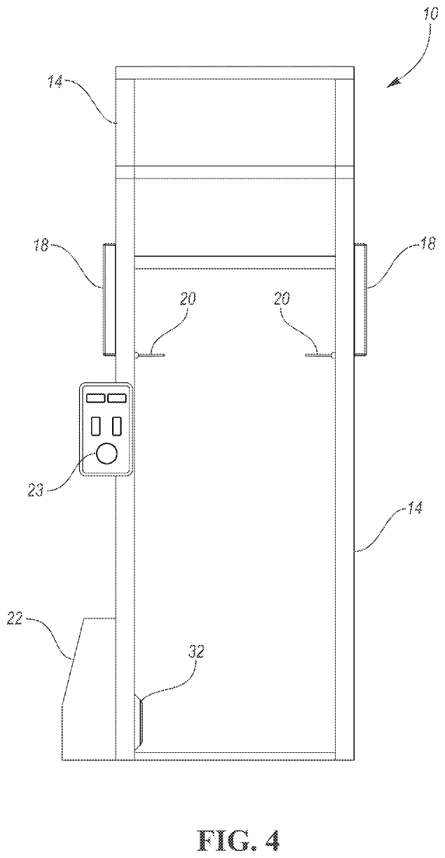

FIG. 4 is a front view of the tray destacker 10 of FIG. 1. The indexing members 20 are shown in a deployed position extending generally toward one another and away from the respective carriages 18.

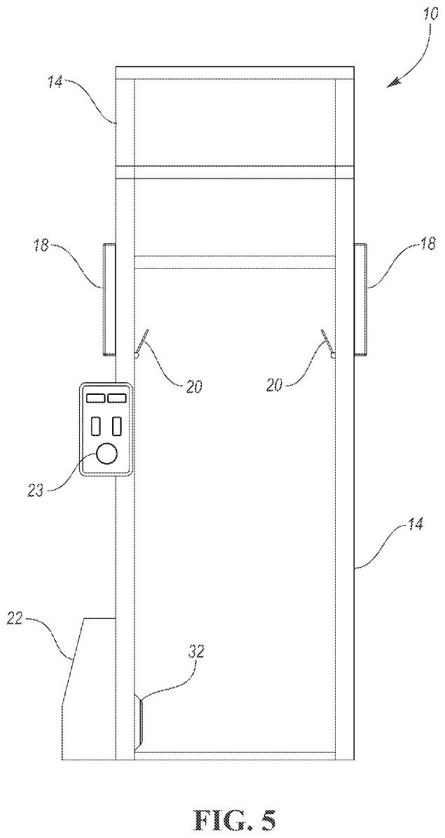

FIG. 5 shows the tray destacker of FIG. 4 with the indexing members 20 in the retracted position. In this example, the indexing members 20 pivot upward to move to the retracted position, but any movement away from one another may be suitable. An actuator moves each indexing member 20 from the deployed position to the retracted position and back again, selectively as commanded by the controller 22.

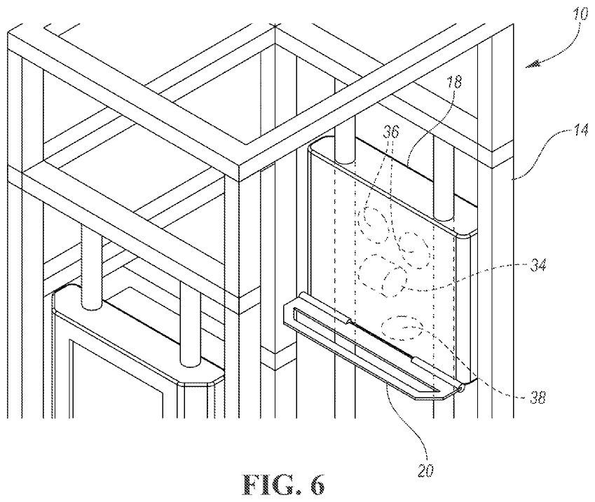

FIG. 6 is an enlarged view of one of the carriages 18 of the tray destacker 10 of FIG. 1 showing internal components schematically. The other carriage 18 would be identical. Each carriage 18 includes a motor 34 that may drive a pair of gears 36 each engaging one of the rails 16 to move the carriage 18 up and down on the rails 16 as controlled by the controller 22.

Each carriage 18 further includes an actuator 38 for moving the indexing members 20 from the deployed position to the retracted position and back again as commanded by the controller 22. The actuator 38 could be an electric motor, hydraulic actuator, or a magnetic actuator.

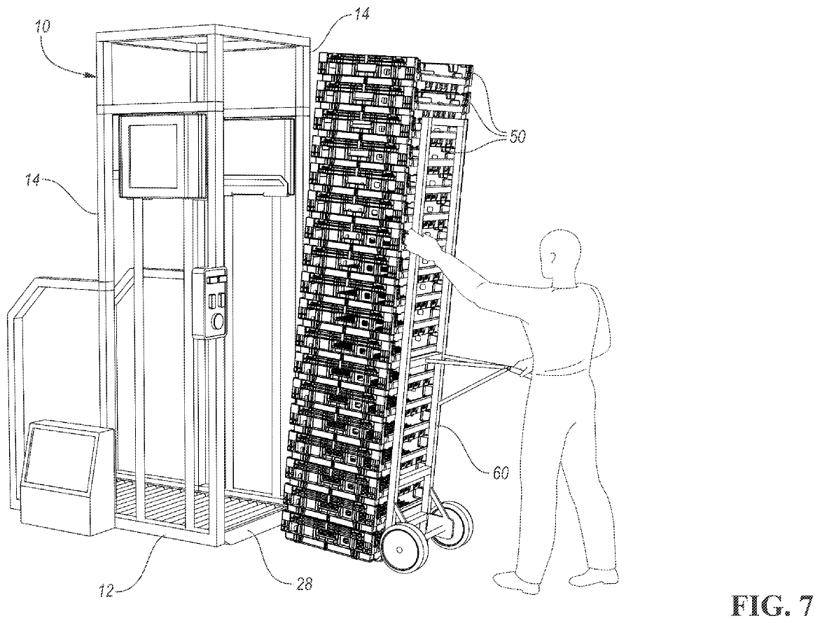

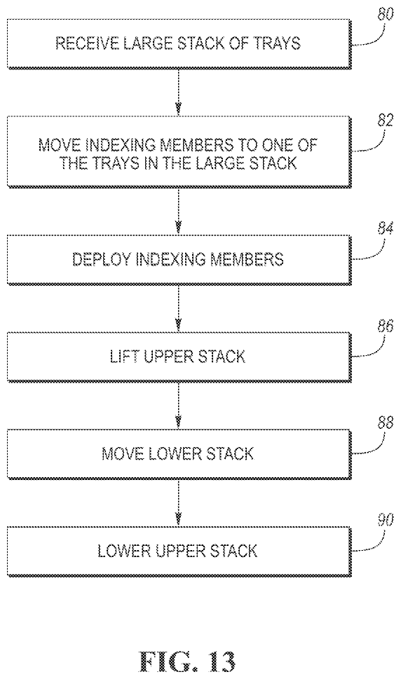

FIG. 13 is a flowchart for the operation of the destacker 10. Referring to FIG. 7 and FIG. 13, in operation, a user brings a stack of trays 50, such as loaded bakery trays 50 on a dolly or hand cart 60. In step 80 (FIG. 13) the tray destacker 10 receives the large stack of trays 50. In this example, the original stack of trays 50 includes seventeen trays 50. The loaded trays 50 are fairly heavy and stacked high above the user's head.

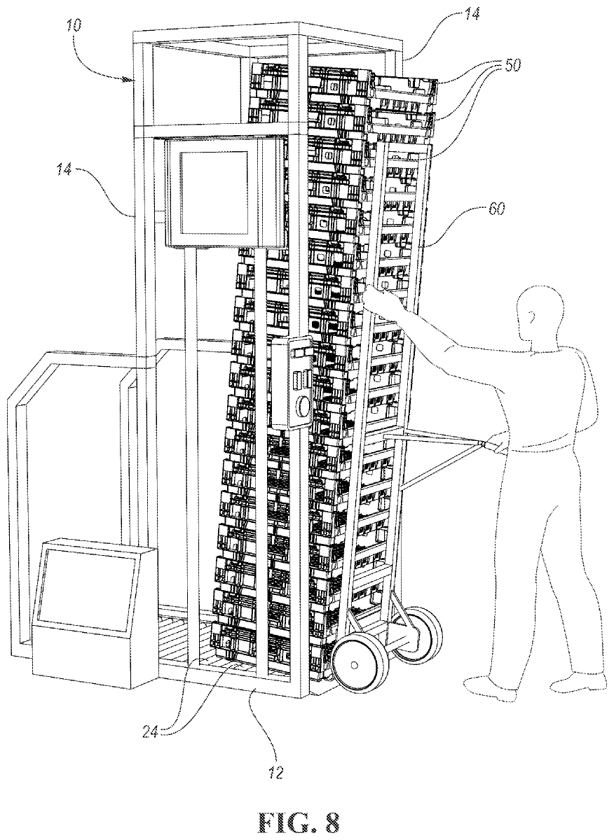

As shown in FIG. 8, the user wheels the hand cart 60 partially into the destacker 10 onto the rollers 24 of the base 12 and between the side walls 14.

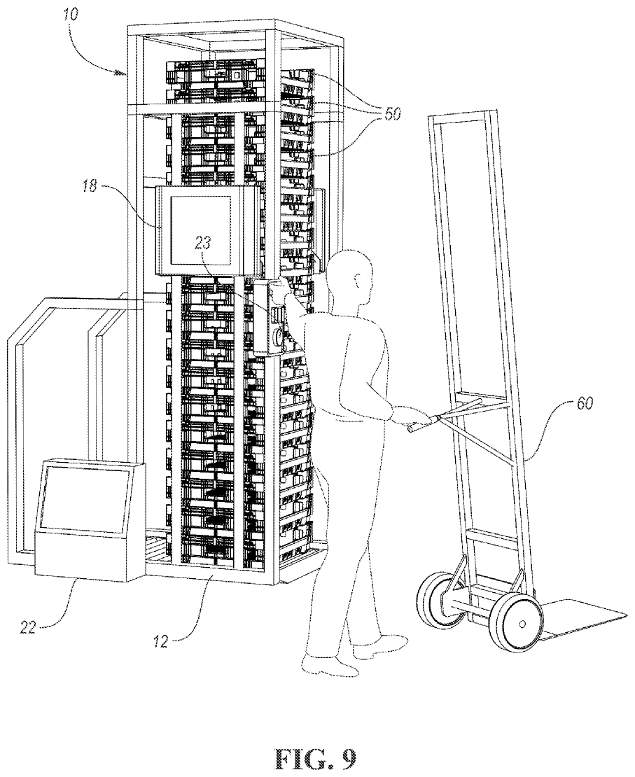

Referring to FIG. 9, the user then removes the hand cart 60 and presses a button 23 connected to the controller 22 to initiate the destacking process. The user can leave in the meantime. As shown, the controller 22 commands the motors 34 in the carriages 18 to move the carriages 18 on the vertical rails 16 toward a point where the indexing members 20 are at an approximate mid-point of the stack of trays 50 (step 82, FIG. 13). Alternatively, the destacker 10 can be programmed to destack the stack of trays 50 into thirds, quarters, etc.

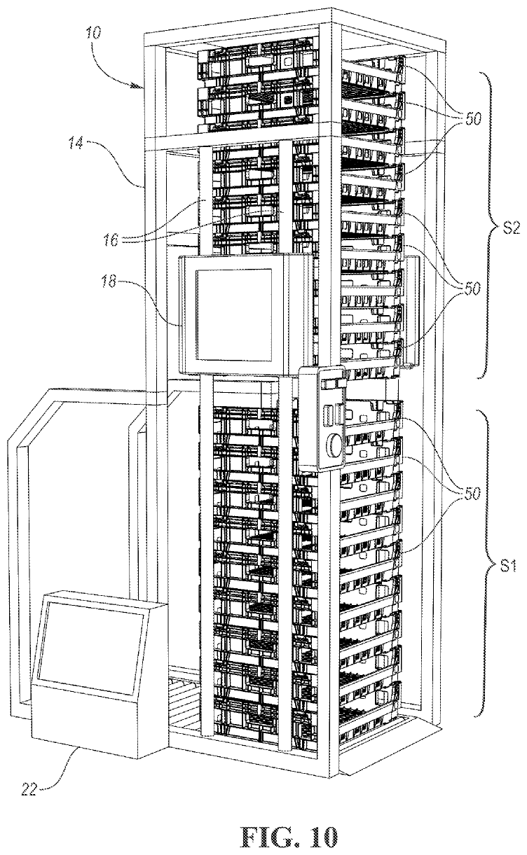

Referring to FIG. 10, the controller 22 commands the actuators 38 (FIG. 6) in each carriage 18 to move the indexing members 20 from the retracted position to the deployed position toward one another (e.g. by pivoting toward one another and away from their respective carriages 18) and under one of the trays 50 (or more specifically under a lip or a handle of the tray 50). (step 84, FIG. 13).

The controller 22 then commands the motors 34 (FIG. 6) in the carriages 18 to drive the carriages 18 up the rails 16, lifting the upper number of trays 50 slightly off the lower number of trays 50. (step 86, FIG. 13).

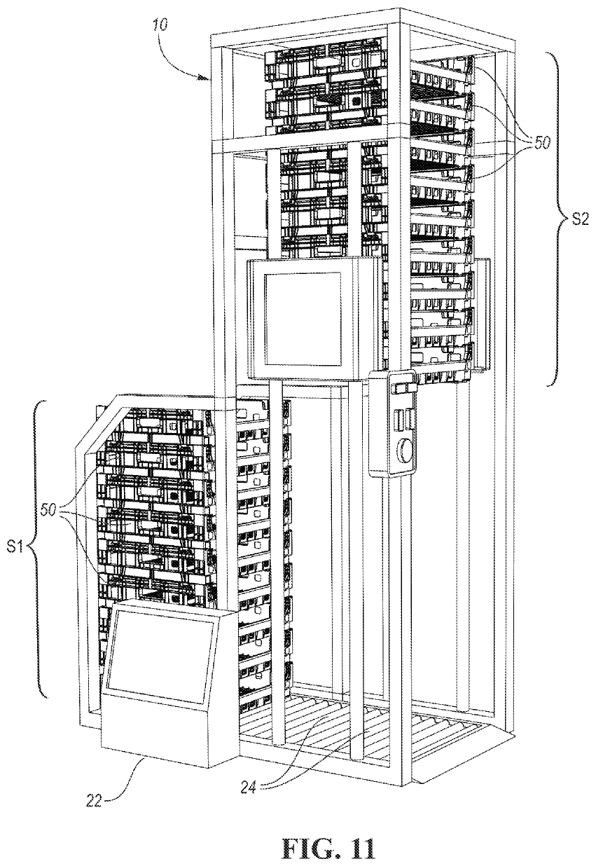

Referring to FIG. 11, the original stack is now broken into a first stack S1 and a second stack S2. The rollers 24 then move the first stack S1 out from under the second stack S2. (step 88, FIG. 13). If the rollers 24 are motorized, the controller 22 controls the rollers 24 to move rearward in the destacker 10 such that the first stack S1 is no longer below the second stack S2.

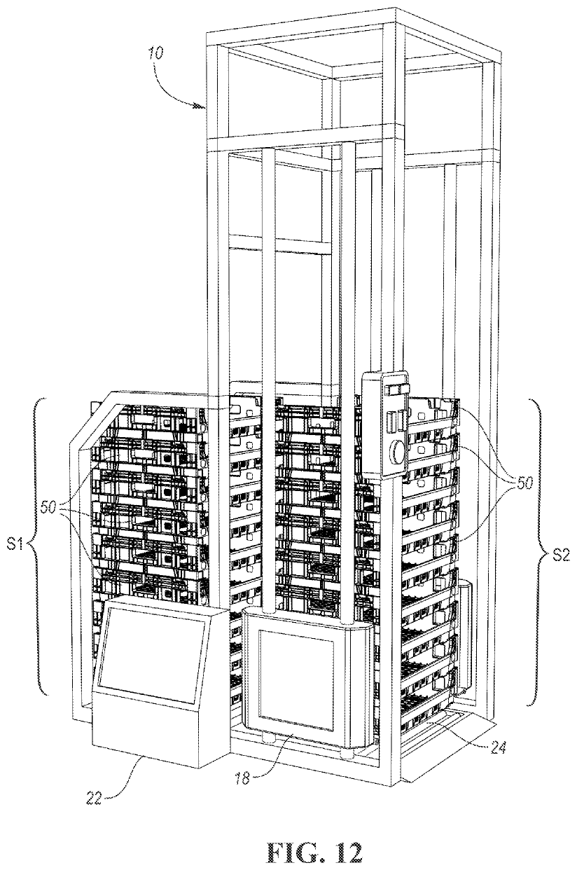

As shown in FIG. 12, the carriages 18 as controlled by controller 22 then lower the second stack S2 onto the base 12 next to the first stack S1. (step 90, FIG. 13). The user or another person can then retrieve the two smaller stacks S1, S2 from the destacker 10.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A tray destacker comprising:
a pair of spaced-apart carriages, movable vertically relative to a frame; and
an indexing member carried by each of the pair of spaced-apart carriages, each indexing member movable between a deployed position in which the indexing members are closer to one another and a retracted position in which the indexing members are further from one another.

2. The tray destacker of claim 1 further including a base, the vertical frame extending upward from the base.

3. The tray destacker of claim 2 wherein the base includes a plurality of rollers on which a stack of trays can be rolled.

4. The destacker of claim 3 further including a motor driving the plurality of rollers.

5. The destacker of claim 4 further including a controller programmed to: a) command the pair of spaced-apart carriages to move to one of a plurality of trays in a large stack between the pair of spaced-apart carriages, b) after step a), command the indexing members to move to the deployed position, and after step b), command the pair of spaced-apart carriages to lift the one of the plurality of trays.

6. The destacker of claim 5 wherein the controller is further programmed to: d) after step c), command the plurality of rollers to move lower trays below the one of the plurality of trays laterally out from under the one of the plurality of trays.

7. The destacker of claim 5 wherein the controller is further programmed to: e) after step d), command the pair of spaced-apart carriages to lower the one of the plurality of trays.

8. The destacker of claim 1 further including a vertical rail to which each of the pair of spaced-apart carriages is mounted.

9. The destacker of claim 8 wherein each of the pair of spaced-apart carriages is movable vertically relative to the respective vertical rail.

10. The destacker of claim 9 wherein each of the pair of spaced-apart carriages includes a motor for moving the carriage vertically relative to the respective vertical rail.

11. The destacker of claim 1 wherein each of the pair of spaced-apart carriages includes a motor for moving the carriage vertically relative to the frame.

12. A method of destacking trays including the steps of:
a) receiving a stack of a plurality of trays, the stack including a first subset of the plurality of trays stacked on a second subset of the plurality of trays;
b) after step a), lifting the second subset of the plurality of trays off of the first subset of the plurality of trays;
c) after step b), moving the first subset of trays laterally out from under the second subset of the plurality of trays; and
d) after step c), lowering the second subset of the plurality of trays.

13. The method of claim 12 wherein step d) includes lowering the second subset of the plurality of trays next to the first subset of the plurality of trays.

14. A tray destacker comprising:
a base having a plurality of rollers;
a frame extending upward from the base;
a pair of carriages movable vertically relative to the frame; and
an indexing member carried by each of the pair of spaced-apart carriages, each indexing member movable between a deployed position in which the indexing members are closer to one another and a retracted position in which the indexing members are further from one another.

15. The destacker of claim 14 further including motors configured to raise and lower the pair of carriages relative to the frame.

16. The destacker of claim 14 further including a motor driving the plurality of rollers.
